(19) United States
(12) Patent Application Publication
(10) Pub. No.: US 2019/0031369 A1
(43) Pub. Date: Jan. 31, 2019

(54) PHOTOGRAPHING DEVICE

(71) Applicant: AUTEL ROBOTICS CO., LTD., Shenzhen (CN)

(72) Inventors: Zhengli ZHANG, Shenzhen (CN); Xiangxi PAN, Shenzhen (CN); Songtao CHANG, Shenzhen (CN)

(21) Appl. No.: 16/136,785

(22) Filed: Sep. 20, 2018

Related U.S. Application Data
(63) Continuation-in-part of application No. PCT/CN2017/096238, filed on Aug. 7, 2017.

(30) Foreign Application Priority Data
Oct. 9, 2016 (CN) 201610885478.6

(51) Int. Cl. B64D 47/08; B64C 39/02; F16M 11/12; H04N 5/232; H04N 5/225

(52) U.S. Cl. CPC B64D 47/08; B64C 39/024; F16M 11/123; B64C 2201/108; H04N 5/2253; B64C 2201/123; B64C 2201/127; H04N 5/23238

(57) ABSTRACT

The present invention relates to a photographing device, including: a plurality of photographing units; a fixing unit, used for fixing the plurality of photographing units (9); and a power system, used for driving the fixing unit to rotate. The photographing device of the present invention is capable of realizing a 360° panorama photographing and realizing stabilization of the plurality of photographing units at the same time.

### CROSS REFERENCE

The present invention is a continuation in part of International Application NO. PCT/CN2017/096238, filed on Aug. 7, 2018, which claims priority of Chinese Patent Application NO. 2016108854786, filed on Oct. 9, 2016, both of which are incooperated herein by reference in their entireties.

### TECHNICAL FIELD

The present invention relates to the field of image photographing, and specifically, to a photographing device.

### RELATED ART

A 360° panoramic video is a video-based live-scene reconstruction technology in which a three-dimensional presentation effect is obtained by using a real video segment, and can play same roles of presentation and recording as that of normal videos. However, a viewing angle range of photographing a normal video is limited. The 360° panoramic video has a viewing angle of 360 degrees×360 degrees. A viewer can randomly select a viewing angle through a tap operation by using 360° panoramic video playing software, which gives the viewer a feel of actually being in a scene of a photographed environment.

Photographing and production costs of the 360° panoramic video are few and production is simple. After a panoramic video is photographed, it takes only several minutes to publish the video since the production is completed, and a standalone version and a network version can be generated. The network version has a very small data volume and has a low requirement on a system, and therefore, is suitable for being watched on various network terminal devices. A real interaction video obtained through 360° panoramic photographing not only can provide important image data for scientific researches, but also can become an important tool of expanding service ranges by merchants. Recently, with development of a 360° panoramic technology, the 360° panoramic technology is applied to wider industry fields. Involved industry fields include tourism, real estate, manufacturing industry, hotels, catering, markets, government planning, transportation, investment attraction, exhibition, education, museums, merchant websites, online stores, and the like.

However, an existing photographing device such as an unmanned aerial vehicle for aerial photography carries one or more stability augmentation gimbals that can photograph only one angle at a same time. A 360° panorama may be obtained through rotation of the gimbal or photographing of a plurality of gimbals at different angles. A disadvantage of a 360° photographing gimbal obtaining a panorama through rotation is that the panorama cannot be obtained at a same time, and therefore cannot satisfy the 3D user experience in VR. Disadvantage of a solution of obtaining a panorama by a plurality of gimbals are that a time difference exists in photographing, causing poor user experience in VR, and the production costs are high.

In view of this, there is a VR stereoscopic photographing device in the prior art. In the photographing device, a plurality of photographing units is fixed on a horizontal support, and stereoscopic photographing is performed by using the plurality of photographing units. When the photographing device is applied to a device such as an unmanned aerial vehicle for panoramic photographing, because a case such as vehicle body inclination exists when the unmanned aerial vehicle flies and the horizontal support in the photographing device cannot move, the photographing device moves with the vehicle body and consequently cannot remain in an optimal photographing position.

### SUMMARY

Therefore, a technical problem to be resolved in the present invention is to overcome a disadvantage that a VR stereoscopic photographing device in the prior art cannot remain in an optimal photographing position, so as to provide a photographing device.

A photographing device includes:

a plurality of photographing units;

a fixing unit, used for fixing the plurality of photographing units; and

a power system, used for driving the fixing unit to rotate.

Further, the photographing device further includes a connecting shaft. One end of the connecting shaft is connected to the fixing unit.

Further, the power system includes a first driving unit, a movable end of the first driving unit being connected to the connecting shaft. The movable end of the first driving unit is an end for driving the connecting shaft to rotate.

Further, the movable end of the first driving unit is a stator or a rotor of the first driving unit.

Further, the photographing device further includes a base, a fixed end of the first driving unit being connected to the base or other external device. The fixed end of the first driving unit is an end not rotating relative to the base.

Further, the power system includes a second driving unit and the photographing device further includes a transmission shaft.

A fixed end of the second driving unit is connected to the transmission shaft and a movable end of the second driving unit is fixedly connected to the fixing unit. The movable end of the second driving unit is an end for driving the fixing unit to rotate and the fixed end is an end fixedly connected to the transmission shaft.

Further, the movable end of the second driving unit is a stator or a rotor of the second driving unit.

Further, one end of the transmission shaft is rotatablely connected to the fixing unit.

Further, the photographing device further includes a fixing plate, the fixing plate being fixedly connected to the fixing unit. The transmission shaft is rotatablely connected to the fixing plate.

Further, the power system includes a third driving unit.

A movable end of the third driving unit is connected to the transmission shaft and a fixed end of the third driving unit is connected to the connecting shaft. The movable end of the third driving unit is an end for driving the transmission shaft to rotate and the fixed end is an end fixedly connected to the connecting shaft.

Further, the movable end of the third driving unit is a stator or a rotor of the third driving unit. Further, a rotation axis of the second driving unit is perpendicular to a rotation axis of the third driving unit.

Further, the photographing unit is inclined downward relative to a plane formed by the rotation axis of the second driving unit and the rotation axis of the third driving unit.

Further, the fixing unit is an orthohexagonal frame and there are three photographing units, an angle between axes of any two photographing units being 120 degrees.

Further, a control plate is fixed on the fixing unit and a control circuit used for controlling the power system and the photographing unit is disposed on the control plate.

Further, a protection cover is further disposed outside the photographing unit.

An unmanned aerial vehicle includes a vehicle body and the photographing device.

Compared with the prior art, the present invention has the following advantages:

1. The driving unit is adopted in the present invention to drive the fixing unit to move in a plurality of directions, so that when the vehicle body of the unmanned aerial vehicle is inclined or rotate, the photographing unit is always in a stable state, to achieve a better photographing effect.

2. The connecting shaft in the present invention is located above a center of the fixing unit. In addition, the photographing unit below is set to be inclined downward relative to the plane formed by the rotation axis of the second driving unit and the rotation axis of the third driving unit, thereby reducing covering of the fixing unit on the photographing unit.

### BRIEF DESCRIPTION OF THE DRAWINGS

To describe technical solutions in specific implementations of the present invention or in the prior art more clearly, the following briefly describes the accompanying drawings required for descriptions in the specific implementations or the prior art. Apparently, the accompanying drawings in the following descriptions show some implementations of the present invention, and a person of ordinary skill in the art may further derive other drawings from these accompanying drawings without creative efforts.

FIG. 1 is a three-dimensional schematic structural diagram of a photographing device according to the present invention;

FIG. 2 is a side view of the photographing device according to the present invention; and

FIG. 3 is a cross-sectional view of the photographing device along K-K direction according to the present invention.

### LIST OF REFERENCE NUMERALS

1: Base; 2: First driving unit; 3: Connecting shaft; 4: Second driving unit; 5: Transmission shaft; 6: Third driving unit; 7: Fixing unit; 8: Control plate; 9: Photographing units; 10: Fixing plate

### DETAILED DESCRIPTION

The following clearly and completely describes the technical solutions in the present invention with reference to the accompanying drawings. Apparently, described embodiments are some but not all of embodiments of the present invention. All other embodiments obtained by a person of ordinary skill in the art based on the embodiments of the present invention without creative efforts shall all fall within the protection scope of the present invention.

In descriptions of the present invention, it should be noted that directions or location relationships indicated by terms such as “center”, “above”, “below”, “left”, “right”, “vertical”, “horizontal”, “inside” and “outside” are directions or location relationships shown based on the accompanying drawings, are merely intended to help to describe the present invention and simplify the descriptions instead of indicating or implying that a specified apparatus or component needs to be in a particular direction or manufactured and operated in a particular direction, and therefore cannot be understood as a limitation on the present invention. In addition, terms “first”, “second” and “third” are merely intended to describe objectives instead of being understood as indicating or implying relative importance.

In the descriptions of the present invention, it should be noted that unless otherwise definitely specified and limited, terms “mount”, “joint” and “connect” should be generally understood as, for example, being fixedly connected, detachably connected or integrally connected; mechanically connected or electrically connected; or directly connected, indirectly connected by using an intermediate medium or internal communication between two components. A person of ordinary skill in the art may understand specific meanings of the terms in the present invention based on a specific condition.

In addition, technical features in different implementations of the present invention described below may be combined with each other, provided that there is no conflict between each other.

### Definition

The “stator” mentioned in the present invention is a portion of a driving unit that doesn't rotate. The “rotator” mentioned in the present invention is a portion of the driving unit that rotates relative to the “stator”. For example, if a rotation shaft of a driving unit rotates, the rotation shaft of the driving unit is that the present invention calls “rotator”. If the rotation shaft of the driving unit doesn't rotate, the rotation shaft of the driving unit is that the present invention calls “stator”.

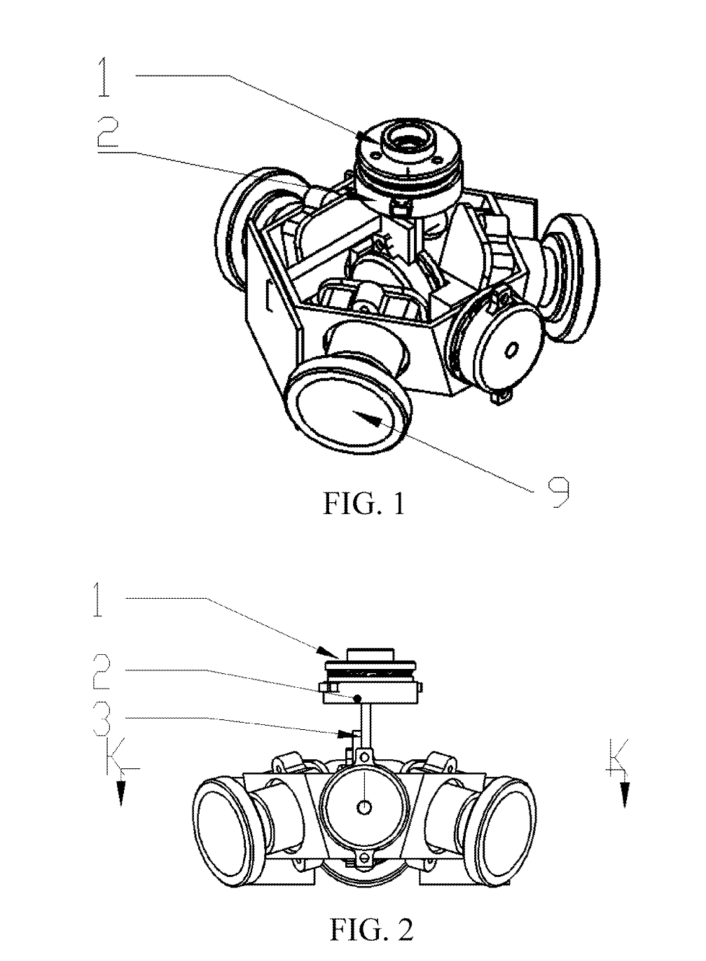

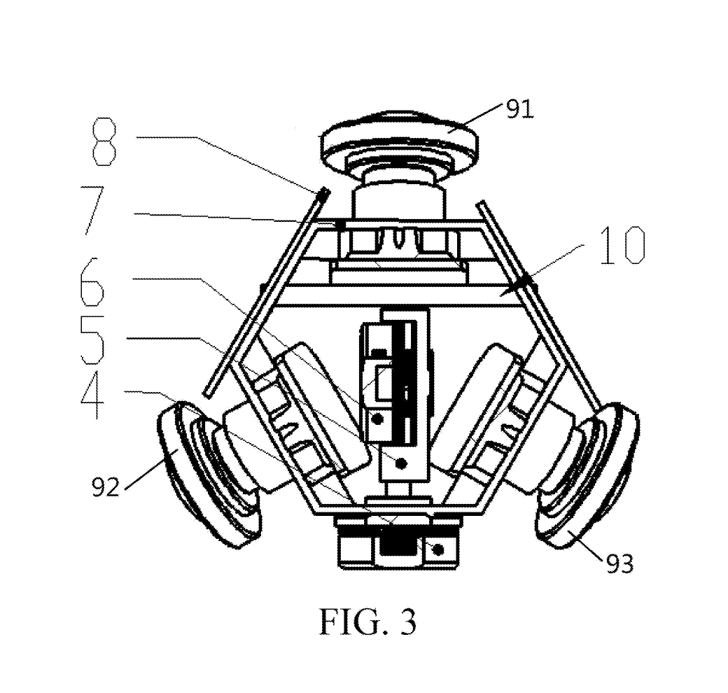

Referring to FIGS. 1-3, the photographing device according to one embodiment of the present invention includes:

a plurality of photographing units 9;

a fixing unit 7, used for fixing the plurality of photographing units 9; and

a power system, coupled to the fixing unit 7 and used for driving the fixing unit 7 to rotate so as to make the plurality of photographing units 9 rotate about at least one axis. The photographing units 9 may be a common camera, a fixed-focus camera, a zoom camera, a fisheye camera or a VR camera.

In one embodiment of the present invention, the power system includes a first driving unit 2 for driving the plurality of photographing units 9 to rotate about yaw axes of their own, a second driving unit 4 for driving at least one of the plurality of photographing units 9 to rotate about its roll axis and a third driving unit 6 for driving at least one of the plurality of photographing units 9 to rotate about its pitch axis. The second driving unit 4 is connected to the fixing unit 7 and the third driving unit 6 is located in a center of the fixing unit 7.

In an embodiment of the present invention, the first driving unit 2, the second driving unit 4 and the third driving unit 6 are all motors. A rotation shaft of the second driving unit 4 is perpendicular to a rotation shaft of the third driving unit 6. The rotation shaft of the second driving unit 4 and the rotation shaft of the third driving unit 6 are on the same plane. An extending direction of a rotation shaft of the first driving unit 2 is perpendicular to the plane formed by the rotation shaft of the second driving unit 4 together with the rotation shaft of the third driving unit 6.

In one embodiment of the present invention, the fixing unit 7 is an orthohexagonal frame and there are three photographing units. An angle between any two photographing units is 120 degrees. In addition, there may alternatively be two, four, five or more photographing units. Photographing directions of the plurality of photographing units 9 are deviated from the center of the fixing unit 7. The plurality of photographing units 9 include a first photographing unit 91, a second photographing unit 92 and a third photographing unit 93. The first photographing unit 91 is disposed on an extending direction of the rotation shaft of the second driving unit 4.

The photographing device further includes a base 1, a stator of the first driving unit 2 being connected to the base 1 or other external device. A rotator of the first driving unit 2 is connected to a stator of the third driving unit 6 via a connecting shaft 3. In an embodiment of the present invention, the rotator of the first driving unit 2 is the rotation shaft of the first driving unit 2.

A rotator of the second driving unit 4 is connected to the fixing unit 7. Specifically, the rotator of the second driving unit 4 is connected to a sidewall of the fixing unit 7. A stator of the second driving unit 4 is connected to a rotator of the third driving unit 6 via a transmission shaft 5. In an embodiment of the present invention, the stator of the second driving unit 4 is the rotation shaft thereof. The rotation shaft of the second driving unit 4 extends towards the third driving unit 6. That is, the rotation shaft of the second driving unit 4 extends towards the center of the fixing unit 7. In an embodiment of the present invention, the photographing device further includes a fixing plate 10 connected to the fixing unit 7. The fixing plate 10 is parallel to a sidewall of the fixing unit 7. Two ends of the fixing plate 10 are connected to the fixing unit 7 respectively. Two ends of the transmission shaft 5 are connected to the fixing plate 10 and the rotation shaft of the second driving unit 4 respectively.

The third driving unit 6 is located in the center of the fixing unit 7. A rotator of the third driving unit 6 is connected to a middle portion of the transmission shaft 5. In an embodiment of the present invention, the rotator of the third driving unit 6 is the rotation shaft of the third driving unit 6.

In an embodiment of the present invention, the first photographing unit 91, the second photographing unit 92 and the third photographing unit 93 are inclined downward relative to the plane formed by the rotation shaft of the second driving unit 4 together with the rotation shaft of the third driving unit 6. In this way, covering of the fixing unit 7 on the photographing unit can be reduced as much as possible, to ensure the optimal photographing effect.

In an embodiment of the present invention, the photographing device further includes a control plate 8. The control plate 8 is fixed on the fixing unit 7 and the control plate 8 includes a control circuit used for controlling the power system and the plurality of photographing units 9. In addition, the control plate 8 may alternatively be disposed in another position, for example, on the base 1.

In other embodiments of the present invention, the photographing device further includes a protection cover for protecting the plurality of the photographing units 9. The protection cover may protect the plurality of photographing units 9 to avoid damage.

When an angle needs to be adjusted, the control plate 8 sends a control signal to control the first driving unit 2, the second driving unit 4 or the third driving unit 6 to rotate. It can be understood that the control plate 8 also can be configured to control two or more driving units to rotate.

When the control plate 8 controls the first driving unit 2 to rotate, because the rotator of the first driving unit 2 is connected to the stator of the third driving unit 6 via the connecting shaft 3, the fixing unit 7 is driven to rotate about the connecting shaft 3. Therefore, the plurality of photographing units 9 are driven to rotate about yaw axes of their own.

When the control plate 8 controls the second driving unit 4 to rotate, because the rotator of the second driving unit 4 is connected to the fixing unit 7, the fixing unit 7 rotates about the rotation shaft of the second driving unit 4. At this moment, the first photographing unit 91 rotates about its roll axis, the second photographing unit 92 and the third photographing unit 93 rotating about pitch axes of their own.

When the control plate 8 controls the third driving unit 6 to rotate, because the rotator of the third driving unit 6 is connected to the fixing unit 7 via the transmission shaft 5, the fixing unit 7 rotates about the rotation shaft of the third driving unit 6. At this moment, the first photographing unit 91 rotates about its pitch axis, the second photographing unit 92 and the third photographing unit 93 rotating about roll axes of their own.

The photographing device of the present invention is capable of realizing a 360° panorama photographing and realizing stabilization of the plurality of photographing units at the same time.

An unmanned aerial vehicle includes a vehicle body, an arm coupled to the vehicle body, an actuating device disposed on the arm and the above mentioned photographing device.

The arm can be fixed on the vehicle body, movably connected to the vehicle body or detachably connected to the vehicle body. The actuating device includes a motor disposed on the arm and a propeller connected to the motor. The motor drives the propeller to rotate so as to generate a thrust or a lifting force to drive the unmanned aerial vehicle to fly.

When a vehicle body of the unmanned aerial vehicle is inclined during flight, the second and the third driving units are adjusted, so that the fixing unit is always in a horizontal state, thereby obtaining a stable photographed picture. When the vehicle body of the unmanned aerial vehicle rotates, the first driving unit is adjusted, so that the fixing unit is always in a static state, thereby obtaining a stable photographed picture.

Obviously, the foregoing embodiments are merely intended to describe the examples clearly instead of limiting the implementations. A person of ordinary skill in the art may further make other changes or variations of different forms based on the foregoing descriptions. There is no need or no way to list all implementations herein. Obvious changes or variations derived from this still fall within the protection scope created in the present invention.

What is claimed is:

1. A photographing device, including:
a fixing unit;
a plurality of photographing units, the plurality of photographing units being disposed on the fixing unit and photographing directions of the plurality of photographing units deviated from a center of the fixing unit; and
a power system, the power system being coupled to the fixing unit and used for driving the fixing unit to rotate so as to make the plurality of photographing units to rotate about at least one axis;
wherein the power system includes:
a first driving unit, used for driving the plurality of photographing units to rotate about yaw axes of their own;
a second driving unit, connecting to the fixing unit and used for driving at least one of the plurality of photographing units to rotate about its roll axis; and
a third driving unit, located in the center of the fixing unit and used for driving at least one of the plurality of photographing units to rotate about its pitch axis.

2. The photographing device according to claim 1, wherein an extending direction of a rotation shaft of the second driving unit is perpendicular to an extending direction of a rotation shaft of the third driving unit, and the rotation shaft of the second driving unit and the rotation shaft of the third driving unit are on the same plane.

3. The photographing device according to claim 2, wherein an extending direction of the first driving unit is perpendicular to the plane formed by the rotation shaft of the second driving unit together with the rotation shaft of the third driving unit.

4. The photographing device according to claim 2, wherein the plurality of photographing units are inclined downward relative to the plane formed by the rotation shaft of the second unit together with the rotation shaft of the third driving unit.

5. The photographing device according to claim 1, wherein a rotator of the first driving unit is connected to a stator of the third driving unit and a stator of the second driving unit is connected with a rotator of the third driving unit.

6. The photographing device according to claim 1, wherein a rotator of the first driving unit is connected to a stator of the third driving unit via a connecting shaft.

7. The photographing device according to claim 1, wherein a rotator of the second driving unit is connected to a sidewall of the fixing unit and a stator of the second driving unit is connected to a rotator of the third driving unit via a transmission shaft.

8. The photographing device according to claim 7 further including a fixing plate;
wherein the stator of the second driving unit is a rotation shaft of the second driving unit, the rotation shaft of the second driving unit extending towards the third driving unit;
wherein two ends of the transmission shaft are connected to the fixing plate and the rotation shaft of the second driving unit respectively, the rotator of the third driving unit being connected to a middle portion of the transmission shaft.

9. The photographing device according to claim 1, wherein the plurality of photographing units includes a first photographing unit, a second photographing unit and a third photographing unit, the first photographing unit, the second photographing unit and the third photographing unit being uniform distributed on the fixing unit.

10. The photographing device according to claim 9, wherein the first photographing unit is disposed on an extending direction of a rotation shaft of the second driving unit, and the first photographing unit is configured to rotate about its roll axis when the fixing unit is driven to rotate by a rotation of a rotator of the second driving unit.

11. The photographing device according to claim 1 further includes a control plate disposed on the fixing unit, wherein the control plate is configured with a control circuit for controlling the driving system and the plurality of photographing units.

12. The photographing device according to claim 1 further includes a protection cover for protecting the plurality of photographing units.

13. An unmanned aerial vehicle, including:
a vehicle body;
an arm coupled to the vehicle body;
an actuating device disposed on the arm; and
a photographing device connecting to the vehicle body;
wherein the photographing device includes:
a fixing unit;
a plurality of photographing units, the plurality of photographing units being disposed on the fixing unit and photographing directions of the plurality of photographing units deviated from a center of the fixing unit; and
a power system, the power system being coupled to the fixing unit and used for driving the fixing unit to rotate so as to make the plurality of photographing units to rotate about at least one axis;
wherein the power system includes:
a first driving unit, used for driving the plurality of photographing units to rotate about yaw axes of their own;
a second driving unit, connecting to the fixing unit and used for driving at least one of the plurality of photographing units to rotate about its roll axis; and
a third driving unit, located in the center of the fixing unit and used for driving at least one of the plurality of photographing units to rotate about its pitch axis.

14. The photographing device according to claim 13, wherein an extending direction of a rotation shaft of the second driving unit is perpendicular to an extending direction of a rotation shaft of the third driving unit, and the rotation shaft of the second driving unit and the rotation shaft of the third driving unit are on the same plane.

15. The photographing device according to claim 14, wherein an extending direction of the first driving unit is perpendicular to the plane formed by the rotation shaft of the second driving unit together with the rotation shaft of the third driving unit.

16. The photographing device according to claim 14, wherein the plurality of photographing units are inclined downward relative to the plane formed by the rotation shaft of the second unit together with the rotation shaft of the third driving unit.

17. The photographing device according to claim 13, wherein a rotator of the first driving unit is connected to a stator of the third driving unit and a stator of the second driving unit is connected to a rotator of the third driving unit.

18. The photographing device according to claim 13, wherein a rotator of the first driving unit is connected to a stator of the third driving unit via a connecting shaft.

19. The photographing device according to claim 13, wherein a rotator of the second driving unit is connected to a sidewall of the fixing unit and a stator of the second driving unit is connected to a rotator of the third driving unit via a transmission shaft.

20. The photographing device according to claim 19 further including a fixing plate;
wherein the stator of the second driving unit is a rotation shaft of the second driving unit, the rotation shaft of the second driving unit extending towards the third driving unit;
wherein two ends of the transmission shaft are connected to the fixing plate and the rotation shaft of the second driving unit respectively, the rotator of the third driving unit being connected to a middle portion of the transmission shaft.

21. The photographing device according to claim 13, wherein the plurality of photographing units includes a first photographing unit, a second photographing unit and a third photographing unit, the first photographing unit, the second photographing unit and the third photographing unit being uniform distributed on the fixing unit.

22. The photographing device according to claim 21, wherein the first photographing unit is disposed on an extending direction of a rotation shaft of the second driving unit, and the first photographing unit is configured to rotate about its roll axis when the fixing unit is driven to rotate by a rotation of a rotator of the second driving unit.

23. The photographing device according to claim 13 further includes a control plate disposed on the fixing unit, wherein the control plate is configured with a control circuit for controlling the driving system and the plurality of photographing units.

24. The photographing device according to claim 13 further includes a protection cover for protecting the plurality of photographing units.
